(19) United States
(12) Patent Application Publication
(10) Pub. No.: US 2017/0253199 A1
(43) Pub. Date: Sep. 7, 2017

(54) ELECTRICAL EQUIPMENT MODULE

(71) Applicant: Yazaki Corporation, Tokyo (JP)

(72) Inventors: Mitsunori Tsunoda, Shizuoka (JP); Syuji Kimura, Shizuoka (JP); Gaku Itou, Shizuoka (JP); Taku Furuta, Shizuoka (JP); Shoichi Nomura, Shizuoka (JP); Naoya Yamashita, Shizuoka (JP)

(21) Appl. No.: 15/449,567

(22) Filed: Mar. 3, 2017

(30) Foreign Application Priority Data
Mar. 4, 2016 (JP) 2016-042326

(51) Int. Cl. B60R 16/02; B60R 16/03

(52) U.S. Cl. CPC B60R 16/0215; B60R 16/03

(57) ABSTRACT

An electrical equipment module includes a main line module, a sub module, and a control connector. The main line module includes a main line routing body that is mounted on a vehicle and is routed along a width direction extending member in a vehicle width direction of the vehicle, and branch units that are interposed in the main line routing body. The sub module is connected to the main line module through the branch units, and is subjected to power supply distribution through the main line routing body. The control connector connects the branch units and the sub module, and performs control of an instrument included in the sub module.

### CROSS-REFERENCE TO RELATED APPLICATION(S)

The present application claims priority to and incorporates by reference the entire contents of Japanese Patent Application No. 2016-042326 filed in Japan on Mar. 4, 2016.

### BACKGROUND OF THE INVENTION

1. Field of the Invention

The present invention relates to an electrical equipment module.

2. Description of the Related Art

Japanese Patent Application Laid-open No. 2003-146150 discloses an instrument panel wire harness device provided with an instrument panel wire harness that is disposed in an instrument panel, and that includes therein a circuit with standard specifications having no influence on the vehicle grade and variations and a branch connection unit; and a plurality of sub modules that are connected to the instrument panel wire harness, and that include a branch wire harness being routed according to the vehicle grade and variations as well as being routed by complete routing, for example, as a conventional electrical equipment module to be applied to a vehicle.

For example, the instrument panel wire harness device disclosed in Japanese Patent Application Laid-open No. 2003-146150 described above can stand further improvement in the mountability.

### SUMMARY OF THE INVENTION

The present invention has been made in view of the above circumstances, and an object of the present invention is to provide an electrical equipment module capable of improving an mountability of the electrical equipment module into a vehicle.

In order to achieve the above mentioned object, an electrical equipment module according to one aspect of the present invention includes a main line module that includes a main line routing body that is mounted on a vehicle and is routed along a width direction extending member in a vehicle width direction of the vehicle, and branch units that are interposed in the main line routing body; a sub module that is connected to the main line module through the branch units, and is subjected to power supply distribution through the main line routing body; and a control connector that connects the branch units and the sub module, and performs control of an instrument included in the sub module.

According to another aspect of the present invention, in the electrical equipment module, it is possible to further include that an intermediate routing body that connects the branch units and the control connector.

According to still another aspect of the present invention, in the electrical equipment module, it is possible to configure that the main line module includes a control function unit that is connected to the main line routing body, and controls distribution of power supply to the sub module and communication with the sub module, and the control connector performs communication between the sub module and the control function unit.

According to still another aspect of the present invention, in the electrical equipment module, it is possible to configure that the main line module is disposed in an instrument panel of the vehicle.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic structure of an electrical equipment module according to an embodiment; and

FIG. 2 is a partial perspective view of a vehicle interior of a vehicle to which the electrical equipment module according to the embodiment is applied.

### DETAILED DESCRIPTION OF THE PREFERRED EMBODIMENTS

An embodiment according to the present invention will now be described in detail with reference to the accompanying drawings. It is to be understood that the present invention is not limited to the embodiment. Furthermore, components of the following embodiment include components that can be easily replaced by persons skilled in the art and components substantially the same.

### EMBODIMENT

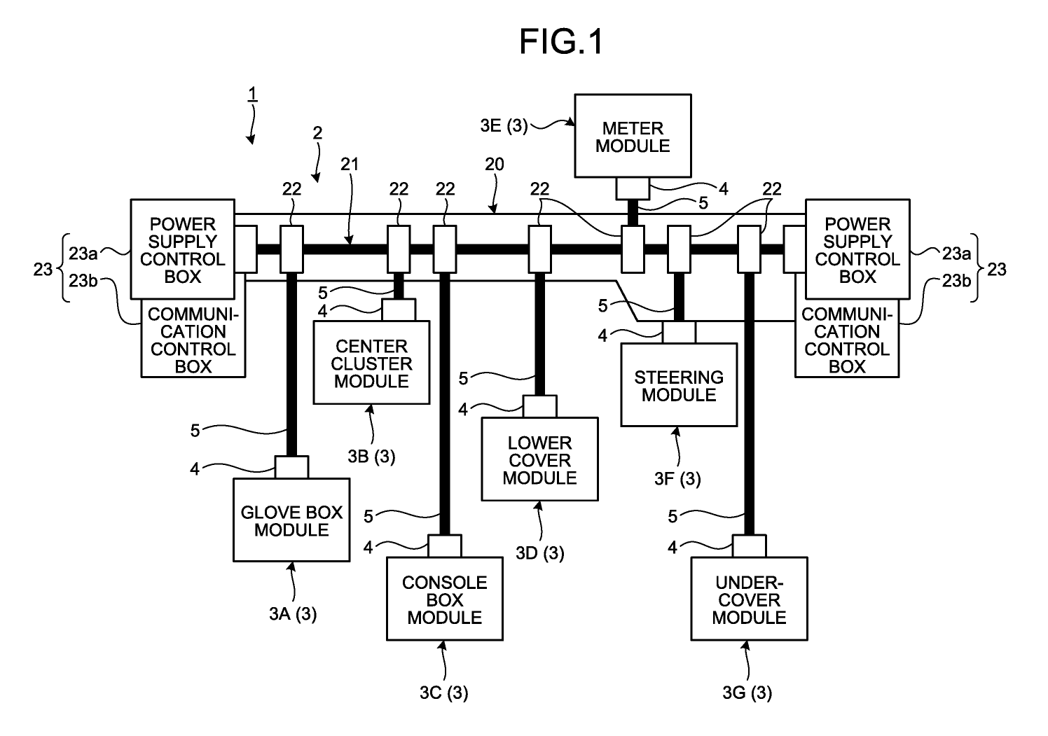

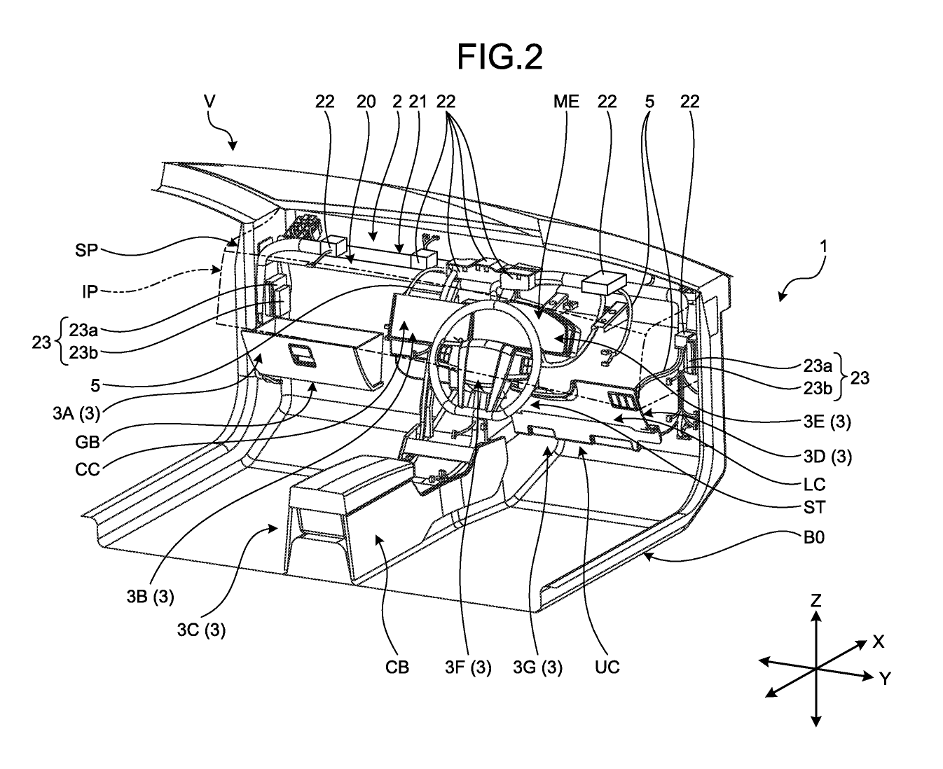

FIG. 1 is a block diagram illustrating a schematic structure of an electrical equipment module according to an embodiment. FIG. 2 is a partial perspective view of a vehicle interior of a vehicle to which the electrical equipment module according to the embodiment is applied. In FIG. 2, an instrument panel is indicated with alternate long and two short dashes line so as to easily illustrate a main line module of the electrical equipment module.

An electrical equipment module 1 of the present embodiment illustrated in FIG. 1 and FIG. 2 is a wire harness module that is applied to a vehicle V, and that is used for supplying power and signal communication, by connecting devices mounted on the vehicle V thereto. Typically, the electrical equipment module 1 of the present embodiment is an instrument panel module in which a main line module 2, which will be described below, is disposed in an instrument panel IP of the vehicle V described above, in a vehicle width direction Y. The instrument panel IP is a member provided inside of the vehicle interior of the vehicle V as well as the front side of the vehicle V in a vehicle longitudinal direction X, in the vehicle width direction Y. In other words, the electrical equipment module 1 as the instrument panel module is a structural module in which the main line module 2 is provided inside of the vehicle interior of the vehicle V as well as in the front side of the vehicle V in the vehicle longitudinal direction X, in the vehicle width direction Y. More specifically, in the electrical equipment module 1, the main line module 2 is disposed in an accommodating space portion SP that is partitioned by a wall surface at the front side of a body BO of the vehicle V in the vehicle longitudinal direction X and the instrument panel IP.

Typically, in the vehicle V to which the electrical equipment module 1 is applied, the “vehicle longitudinal direction X” corresponds to the whole length direction of the vehicle V, more specifically, in the advancing longitudinal direction of the vehicle V. Typically, the “vehicle width direction Y” corresponds to the whole width direction of the vehicle V, and corresponds to the vehicle horizontal direction of the vehicle V. Typically, a “vehicle height direction Z” corresponds to the vehicle height direction of the vehicle V. The vehicle longitudinal direction X that is a first direction, the vehicle width direction Y that is a second direction, and the vehicle height direction Z that is a third direction are orthogonal to each other, and when the vehicle V is on a horizontal surface, the vehicle longitudinal direction X and the vehicle width direction Y are in the horizontal direction, and the vehicle height direction Z is in the vertical direction. Furthermore, in the following explanation, in the vehicle longitudinal direction X, the side toward which the vehicle V moves forward may be referred to as “front”, and the side toward which the vehicle V moves backward may be referred to as “rear”. In the vehicle width direction Y, the left side (left side in FIG. 2) facing the front in the vehicle longitudinal direction X may be referred to as “left side”, and the right side (right side in FIG. 2) facing the front in the vehicle longitudinal direction X may be referred to as “right side”. In the vehicle height direction Z, the upper side in the vertical direction may be referred to as “upper side”, and the lower side in the vertical direction may be referred to as “lower side”. Unless otherwise specifically indicated, the directions used in the following explanation indicate directions in a state when the units are assembled with one another.

The mountability of the electrical equipment module 1 of the present embodiment to the vehicle V is improved, by connecting various sub modules 3 to the main line module 2 that extends in the instrument panel IP in the vehicle width direction Y. Hereinafter, the structure of the electrical equipment module 1 will be described in detail with reference to the accompanying drawings.

More specifically, the electrical equipment module 1 includes the main line module 2, the sub module 3, a communication control connector 4 as a control connector, and an intermediate routing body 5.

The main line module 2 is a structural module in the instrument panel IP, more specifically, the structural module in an instrument panel that extends in the accommodating space portion SP in the vehicle width direction Y, and to which the sub module 3, which will be described below, is connected. The main line module 2 includes a main line routing body 21 and a plurality of branch boxes 22 as branch units. The main line routing body 21, in which the branch boxes 22 are disposed at intervals, is routed along a width direction extending member 20, to form a main line. The main line module 2 may be made into a module by including the width direction extending member 20, or may be made into a module by not including the width direction extending member 20. Furthermore, the main line module 2 includes a control function unit 23.

The width direction extending member 20 is a member that is mounted on the vehicle V, and that extends in the instrument panel IP, more specifically, in the accommodating space portion SP in the vehicle width direction Y. The width direction extending member 20 of the present embodiment is a structure strength member or what is called a reinforcement that extends in the instrument panel IP in the vehicle width direction Y, and makes a steering ST supported by the body BO. The reinforcement that configures the width direction extending member 20 may be made of metal or may be made of resin having high rigidity. In this example, the sectional shape of the reinforcement that configures the width direction extending member 20 has a substantially circular shape. However, it is not limited thereto, and the sectional shape of the reinforcement may be a substantially H shape or a substantially rectangular shape. Both ends of the width direction extending member 20 in the vehicle width direction Y are fixed to the body BO. While the width direction extending member 20 is fixed to the body BO, the width direction extending member 20 extends in the instrument panel IP from the right end to the left end in the vehicle width direction Y.

The main line routing body 21 is a main line routing body routed along the width direction extending member 20. In this example, the main line routing body 21 is mounted on a surface at the upper side of the width direction extending member 20 in the vehicle height direction Z, and is routed in the vehicle width direction Y. The main line routing body 21 is a bundle of a plurality of electric wires including an electric power line for supplying power, a communication line for signal communication, an earth cable for grounding, and the like. For example, the electric wire that forms the main line routing body 21 includes a conductor unit (core wire) formed by stranding a plurality of conductive metal wires and an insulated cover unit that covers the outside of the conductor unit. The main line routing body 21 may also include a cable for optical communication. The main line routing body 21 is routed along the width direction extending member 20, and for example, fixed to the width direction extending member 20 using various fixing tools such as clamps and clips. For example, the main line routing body 21 may also be assembled to the width direction extending member 20 using what is called a noise grounding clamp that can be used for ground connection in addition to assembling and the like.

The branch boxes 22 are portions that are interposed in the main line routing body 21, and each of the branch boxes 22 branches a circuit configured by the main line routing body 21. In the main line module 2, the branch box 22 is a connecting part used for electrically connecting the sub module 3, which will be described below (sub module 3 may also be optically connected according to the need (in the following similar description, it is assumed that the sub module 3 is optically connected according to the need)). The branch box 22 distributes power supplied from a power supply, signals, and the like that are transmitted through the main line routing body 21, to the sub module 3. The branch box 22 may also include a circuit protection unit such as a fuse for protecting an electric circuit of the sub module 3 from large current equal to or more than the rated current. The branch box 22 may also include a receiving connector that is a portion used for connecting each of the branch boxes 22 to the sub module 3, and the like. The branch boxes 22 are provided on the main line routing body 21, and in this example, seven of the branch boxes 22 are provided according to the number of the sub module 3, which will be described below. Typically, the main line routing body 21 that is routed so as to connect the branch boxes 22 is electrically connected to each of the branch boxes 22 through a connection unit such as a connector. It is preferable that the main line routing body 21 is configured as a linear body that does not include a branch in itself.

The control function unit 23 is connected to the main line routing body 21, and controls the distribution of power to the sub module 3 and the communication with the sub module 3. The control function unit 23 is electrically connected to each of both ends of the main line routing body 21 in the vehicle width direction Y. Each of the control function units 23 is connected to the main line routing body 21 through a connector and the like. In this example, each of the control function units 23 includes a power supply control box 23a and a communication control box 23b. However, it is not limited thereto, and for example, the power supply control box 23a and the communication control box 23b may be configured integrally. Furthermore, the control function unit 23 need not be connected to both ends of the main line routing body 21, and may be connected to one of the ends of the main line routing body 21.

Each of the power supply control boxes 23a is made into a unit box by integrating a function of distributing power to the sub module 3 that is connected to the main line module 2, a function of controlling power supply, and the like, by electronic function components built into the casing. In other words, each of the power supply control boxes 23a has a function of what is called an electrical connection box such as a junction block, a fuse box, and a relay box that distributes power supplied from the power supply, to various kinds of equipment in the sub module 3 connected to the main line module 2. Furthermore, each of the power supply control boxes 23a may be made into a unit box by integrating a power supply backup function for backing up a power supply mounted on the vehicle V, such as a generator like an alternator and a battery, by the electronic function components built into the casing. In other words, each of the power supply control boxes 23a may be an electronic component unit in which various functions such as distributing power, controlling the units, and backing up the power supply are integrated. The electronic function components built into each of the power supply control boxes 23a are various elements for exerting various functions described above, and are configured including various function components. For example, the electronic function components built into each of the power supply control boxes 23a include at least one of a power supply distribution function component that distributes power to the sub module 3, a power supply control function component that controls power supply, or a power supply backup function component that backs up the power supply to be mounted on the vehicle V. The power supply distribution function component is a relay; a fuse; a resistance; a transistor; an intelligent power switch (IPS); a power supply control box in which the relay, the fuse, the resistance, the transistor, and the IPS are made into a unit; and the like, for example. The power supply control function component is an electronic control unit (ECU) including a microcomputer, for example. In other words, the power supply backup function component is a distribution power supply function component such as a capacitor, a secondary battery unit, and a thin sheet battery.

Each of the communication control boxes 23b is made into a unit box by integrating a function of performing various types of communication with the sub module 3, a function of controlling communication, and the like, by the electronic function component, an optical function component, and the like, that are built into the casing. Furthermore, each of the communication control boxes 23b may also be made into a unit box by integrating a wireless communication function and the like in the vehicle V, by the electronic function component, the optical function component, and the like, that are built into the casing. In other words, each of the communication control boxes 23b may be referred to as an electronic component unit in which various functions relating to communication are integrated. The electronic function component and the optical function component that are built into each of the communication control boxes 23b are various elements for exerting various functions described above, and are configured including various function components. For example, the electronic function component and the optical function component that are built into each of the communication control boxes 23b include at least one of a communication function component that performs various types of communication, a communication control function component that controls communication, or a wireless communication function component that performs wireless communication. The communication function component is various transmitting/receiving devices, for example. The communication control function component is the ECU including a microcomputer, for example. For example, the wireless communication function component is a transmitting/receiving unit of various systems including a wireless LAN (W-LAN), Wi-Fi (registered trademark), and near field communication (NFC) such as Bluetooth (registered trademark) and an antenna. The antenna may receive information from electronic toll collection (ETC), global positioning system (GPS), telephone (TEL), and vehicle information and communication system (VICS)(registered trademark), for example.

The sub module 3 is electrically connected to various kinds of equipment through a routing circuit such as an electric wire and a bus bar. The sub module 3 is made into a module so as to be a circuit with high density and high efficiency according to an arrangement area in the vehicle V. The sub module 3 is connected to the main line module 2 through the branch box 22, and power supply is distributed thereto at least through the main line routing body 21. Typically, the sub module 3 is electrically connected to the branch box 22 of the main line module 2 through a connector (for example, the communication control connector 4, which will be described below), the intermediate routing body 5, and the like. Power supply and signal communication are performed between various kinds of equipment and the control function unit 23 or the like, through the main line routing body 21 and the like. The sub module 3 may also perform a part of signal communication by various wireless communication systems, through the wireless communication function component and the like of the communication control boxes 23b described above. Furthermore, power may be supplied to the sub module 3 using various non-contact power supply systems. Furthermore, various kinds of equipment in the sub module 3 may be connected by wire using a routing circuit such as an electric wire and a bus bar, or may be connected using various wireless communication systems. A plurality of the sub modules 3 are provided. In this example, a total of seven of the sub modules 3 including a glove box module 3A, a center cluster module 3B, a console box module 3C, a lower cover module 3D, a meter module 3E, a steering module 3F, and an undercover module 3G are provided.

The glove box module 3A includes various kinds of equipment provided in a glove box GB. The glove box GB is an openable and closable storage unit placed at the front side of a passenger's seat in the vehicle V in the vehicle longitudinal direction X. The glove box module 3A includes, for example, a lighting device that is turned off when the glove box GB is closed and turned on when the glove box GB is opened as various kinds of equipment.

The center cluster module 3B includes various kinds of equipment provided in a center cluster CC. The center cluster CC is a fixed storage unit provided around the center of the instrument panel IP in the vehicle width direction Y. Examples of the center cluster module 3B include various switches for operating audio, multimedia, and air conditioning devices, and the like, and a navigation device, as the various kinds of equipment.

The console box module 3C includes various kinds of equipment provided in a console box CB. The console box CB is an openable and closable storage unit that is placed between the driver's seat and the passenger's seat in the vehicle V. The console box module 3C includes, for example, equipment for connecting therewith an external device such as a 100 V outlet, a 12 V socket, an USB socket, and a High Definition Multimedia Interface (HDMI)(registered trademark) socket; a non-contact power supply device of various systems that can charge portable terminal devices such as a smartphone, a tablet, and a game device in an non-contact manner; and a transmitting/receiving unit of various systems that can wirelessly communicate with the portable terminal devices, as various kinds of equipment.

The lower cover module 3D includes various kinds of equipment provided in a lower cover LC. The lower cover LC is a cover member that covers, in the right side of the instrument panel IP in the vehicle width direction Y, the lower side of the instrument panel IP in the vehicle height direction Z. The lower cover module 3D includes, for example, various switches such as a trunk opener, as various kinds of equipment.

The meter module 3E includes various kinds of equipment provided in a meter ME. The meter ME is a display device placed in the front side of the driver's seat in the vehicle longitudinal direction X, in the instrument panel IP. The meter module 3E includes, for example, an analogue instrument, an image display device, or the like that displays various types of information relating to the vehicle V, such as the speed of the vehicle V, accumulated mileage, cooling water temperature, output rotating speed of a traveling power source, remaining amount of fuel, amount of battery storage, warning information (telltales), shift position indicator, and information on eco-driving, as various kinds of equipment.

The steering module 3F includes various kinds of equipment provided on a steering ST. Examples of the steering module 3F include various switches for operating audio, multimedia, and air conditioning devices, and the like; various sensors for detecting the steering angle of the steering ST and the like; an airbag device; a horn device; and the like, as various kinds of equipment. For example, in the steering module 3F, signal communication is performed between various kinds of equipment and the control function unit 23 or the like, for the equipment that form an operating system relating to traveling of the vehicle V such as various sensors for detecting the steering angle of the steering ST as well as the equipment that form a safety system such as an air bag device and a horn device, through a connector (for example, the communication control connector 4, which will be described below), the intermediate routing body 5, the main line routing body 21, or the like, in a wired manner. In addition, in the steering module 3F, signal communication may be performed for, for example, various kinds of equipment not relating to traveling or safety of the vehicle V such as various switches for operating audio, multimedia, or air conditioning devices, through a wireless communication function component or the like of the communication control boxes 23b, using various wireless communication systems. In this case, in the steering module 3F, power may be supplied between various kinds of equipment and the control function unit 23 or the like through the connector, the intermediate routing body 5, the main line routing body 21, or the like in a wired manner, or the power may be supplied in a wireless manner using various non-contact power supply systems. Furthermore, the steering module 3F may include a wireless communication module or the like to cause all communication to be performed wirelessly. In addition, as for the supplying of power, the steering module 3F may have a configuration without what is called a clock spring (such as ribbon shaped electrical wiring), or a clock springless configuration, by configuring a power supply system independent from the other modules. In this case, the steering module 3F includes various generation units such as a piezoelectric element and a solar light panel, as well as a secondary battery capable of storing the generated battery, in the steering module 3F itself.

The undercover module 3G includes therein various kinds of equipment provided in an undercover UC. The undercover UC is a cover member that covers an opening formed at the lower side of the lower cover LC in the vehicle height direction Z. The undercover module 3G includes, for example, a lighting device for lighting one's feet, an on-board diagnostics (OBD) device, a connection unit for connecting terminal equipment that updates software of various kinds of equipment, as various kinds of equipment.

The communication control connector 4 is a connection function component that electrically connects the sub module 3 and the main line module 2. More specifically, the communication control connector 4 electrically connects the branch box 22 and the sub module 3, and controls the equipment included in the sub module 3. In this example, the communication control connector 4 also communicates between the sub module 3 and the control function unit 23. The communication control connector 4 is configured as a connection function component that connects the intermediate routing body 5 and the sub module 3, and is provided at a connection portion between the sub module 3 and the intermediate routing body 5. The communication control connector 4 includes therein a connection terminal for connecting the intermediate routing body 5 and the sub module 3, a housing for holding the connection terminal, and the like. Furthermore, an electronic control unit including various control microcomputers and a control function component such as the ECU are built into the housing. The communication control connector 4 can mutually communicate with the function components of the control function unit 23 by the control function component, and controls communication between the sub module 3 and the control function unit 23, and controls the equipment included in the sub module 3.

The intermediate routing body 5 is a routing body that is interposed between the branch box 22 and the communication control connector 4 described above, and that electrically connects the branch box 22 and the communication control connector 4. The intermediate routing body 5 is configured of an electric wire that configures an electric power line for supplying power, a communication line for signal communication, an earth cable for grounding, and the like; a planar circuit (for example, a flexible printed circuit (FPC) and a flexible flat cable (FFC)); a bus bar; a cable for optical communication; and the like. The branch box 22 is connected to one of the ends of the intermediate routing body 5, and the communication control connector 4 is connected to the other end. The intermediate routing body 5 may be connected to the branch box 22 through a connector and the like, or may be connected to the branch box 22 using the other connection structure.

The electrical equipment module 1 described above includes the main line module 2, the sub module 3, and the communication control connector 4. The main line module 2 includes the main line routing body 21 that is mounted on the vehicle V and that is routed along the width direction extending member 20 in the vehicle V, in the vehicle width direction Y, as well as the branch boxes 22 that are interposed in the main line routing body 21. The sub module 3 is connected to the main line module 2 through each of the branch boxes 22, and supplied with power distributed through the main line routing body 21. The communication control connector 4 connects the branch box 22 and the sub module 3, and controls the equipment included in the sub module 3.

Consequently, in the electrical equipment module 1, the main line module 2 is configured by routing the main line routing body 21, in which the branch boxes 22 are disposed at intervals, along the width direction extending member 20, and connecting the sub module 3 to the main line module 2 through each of the branch boxes 22. Thus, the communication control connector 4 that connects the branch box 22 and the sub module 3 can control the equipment included in the sub module 3. As a result, the electrical equipment module 1 can be assembled to the vehicle V, while assembling and mutually connecting the main line module 2 and the sub module 3 to the vehicle V. Thus, for example, it is possible to reduce the amount of work relating to the routing of the main line routing body 21, the connection of the sub module 3, and the like, as well as to improve the assembling efficiency, thereby improving the mountability of the electrical equipment module 1 to the vehicle V. Furthermore, in the electrical equipment module 1, the main line routing body 21 that configures the main line module 2 is formed as a linear body in which the branch boxes 22 are disposed at intervals and a branch is not included in the main line routing body 21 itself, thereby simplifying the mode of the main line module 2 and making the main line module 2 more compact and space-saving. Consequently, the electrical equipment module 1 can improve the workability during assembly, prevent the number of components from increasing, and improve the manufacturing efficiency. In other words, in the electrical equipment module 1, the branching between the main line module 2 and the equipment included in each of the sub modules 3 is integrated to each of the branch boxes 22 that are interposed in the main line routing body 21. Furthermore, as the whole mode of the electrical equipment module 1 is simplified, it is possible to improve the workability during assembly and prevent the number of components from increasing. Consequently, for example, it is possible to simplify the handling and coordination of various routing bodies, and improve the mountability of the electrical equipment module 1 to the vehicle V.

Furthermore, the electrical equipment module 1 described above includes the intermediate routing body 5 that connects the branch box 22 and the communication control connector 4. Consequently, by connecting the branch box 22 and the communication control connector 4 using the intermediate routing body 5, the electrical equipment module 1 can connect the main line module 2 and the sub module 3 through the communication control connector 4 and the intermediate routing body 5. Thus, the electrical equipment module 1 can improve the versatility of connection between the main line module 2 and the sub module 3, and can be easily applied to various vehicles V.

Furthermore, in the electrical equipment module 1 described above, the main line module 2 is connected to the main line routing body 21, and includes the control function unit 23 that controls the distribution of power supply to the sub module 3 and the communication with the sub module 3. The communication control connector 4 communicates between the sub module 3 and the control function unit 23. Consequently, in the electrical equipment module 1, even if the equipment included in the sub module 3 is not individually connected to the control function unit 23 through the main line module 2, the communication control connector 4 can integrally communicate between the sub module 3 and the control function unit 23, as well as control the equipment included in the sub module 3. Thus, it is possible to further reduce the amount of work relating to the routing and the like, and improve the mountability of the electrical equipment module 1 to the vehicle V.

Furthermore, in the electrical equipment module 1 described above, the main line module 2 is disposed in the instrument panel IP of the vehicle V. Consequently, it is possible to improve the mountability of the electrical equipment module 1 to the vehicle V, by the instrument panel module in which the main line module 2 is disposed in the instrument panel IP of the vehicle V.

The electrical equipment module according to the embodiment of the present invention described above is not limited to the embodiment described above, and various modifications may be made within the spirit and scope of the appended claims.

For example, the vehicle to which the electrical equipment module 1 described above is to be applied, may be a vehicle that can implement high function automatic driving in which a driver does not need to perform a steering operation and the like. In this case, the vehicle to which the electrical equipment module 1 is applied may be a vehicle not including a structural strength member, or what is called reinforcement, that extends in the instrument panel IP in the vehicle width direction Y and that makes the steering ST supported by the body BO. In this case, for example, the vehicle has what is called a steering-by-wire system in which the steering ST and the steering wheel are not mechanically connected, and for example, the steering ST is supported by the floor of the body BO through a support arm and the like. Furthermore, for example, in the vehicle, the steering ST may be stored in a predetermined storage position with various pedals, during automatic driving when the operation by the driver is not required. In this case, the width direction extending member may be another member that extends in the instrument panel IP in the vehicle width direction, for example, a structure that is generally mounted in the instrument panel IP of the vehicle, such as an air conditioning duct that is formed in a hollow shape and through which the air can flow. Furthermore, the width direction extending member may be an exclusive component that is formed separately from the air conditioning duct and that is used for routing the main line routing body 21.

The electrical equipment module 1 described above includes the intermediate routing body 5. However, it is not limited thereto, and the electrical equipment module 1 may not include the intermediate routing body 5. In this case, in the electrical equipment module 1, the communication control connector 4 is directly connected to the branch box 22, and the sub module 3 is connected to the main line module 2 through the branch box 22. In this case, the communication control connector 4 is configured as a connection function component for connecting the branch box 22 and the sub module 3, and is configured including a connection terminal for connecting the branch box 22 and the sub module 3, a housing for holding the connection terminal, and the like. Furthermore, an electronic control unit including various control microcomputers and a control function component such as the ECU are built into the housing.

In the electrical equipment module 1 described above, the main line module 2 may be electrically connected to the other on-board module.

In the above description, the sub module 3 has a total of seven of the glove box module 3A, the center cluster module 3B, the console box module 3C, the lower cover module 3D, the meter module 3E, the steering module 3F, and the undercover module 3G. However, it is not limited thereto.

In the above explanation, the control connector is the communication control connector 4. However, it is not limited thereto, and the control connector may not have the function of communicating between the sub module 3 and the control function unit 23.

The electrical equipment module 1 described above is the instrument panel module that is disposed in the instrument panel IP of the vehicle V in the vehicle width direction Y. However, it is not limited thereto, and the electrical equipment module 1 may be an on-board module that is disposed on the other position in the vehicle V.

In the electrical equipment module according to the present embodiment, the main line module is configured by routing the main line routing body, in which the branch units are disposed at intervals, along the width direction extending member, and connecting the main line module to the sub module through each of the branch units. Thus, the control connector that connects the branch units and the sub module can control the equipment included in the sub module. As a result, the electrical equipment module can be assembled to the vehicle, while assembling and mutually connecting the main line module and the sub module to the vehicle. Consequently, for example, it is possible to reduce the amount of work relating to the routing of the main line routing body, the connection of the sub module, and the like, and to improve the assembling efficiency, thereby improving the mountability of the electrical equipment module to the vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical equipment module comprising:
a main line module that includes a main line routing body that is mounted on a vehicle and is routed along a width direction extending member in a vehicle width direction of the vehicle, and branch units that are interposed in the main line routing body;
a sub module that is connected to the main line module through the branch units, and is subjected to power supply distribution through the main line routing body; and
a control connector that connects the branch units and the sub module, and performs control of an instrument included in the sub module.

2. The electrical equipment module according to claim 1, further comprising:
an intermediate routing body that connects the branch units and the control connector.

3. The electrical equipment module according to claim 1, wherein
the main line module includes a control function unit that is connected to the main line routing body, and controls distribution of power supply to the sub module and communication with the sub module, and
the control connector performs communication between the sub module and the control function unit.

4. The electrical equipment module according to claim 1, wherein
the main line module is disposed in an instrument panel of the vehicle.

5. The electrical equipment module according to claim 2, wherein
the main line module includes a control function unit that is connected to the main line routing body, and controls distribution of power supply to the sub module and communication with the sub module, and
the control connector performs communication between the sub module and the control function unit.

6. The electrical equipment module according to claim 2, wherein
the main line module is disposed in an instrument panel of the vehicle.

7. The electrical equipment module according to claim 3, wherein
the main line module is disposed in an instrument panel of the vehicle.
